(19) United States
(12) Patent Application Publication
(10) Pub. No.: US 2024/0219677 A1
(43) Pub. Date: Jul. 4, 2024

(54) OPTICAL MEMBER DRIVING MECHANISM

(71) Applicant: TDK TAIWAN CORP., Taoyuan City (TW)

(72) Inventors: Kai-Po FAN, Taoyuan City (TW); Man-Ting LU, Taoyuan City (TW); Shou-Jen LIU, Taoyuan City (TW)

(21) Appl. No.: 18/400,670

(22) Filed: Dec. 29, 2023

Related U.S. Application Data
(60) Provisional application No. 63/436,291, filed on Dec. 30, 2022.

(51) Int. Cl. G02B 7/04

(52) U.S. Cl. CPC G02B 7/04

(57) ABSTRACT

An optical member driving mechanism is provided. The optical member driving mechanism includes a movable portion, a fixed portion, and a driving assembly. The movable portion is configured to connect an optical member. The movable portion is movable relative to the fixed portion. The driving assembly is configured to drive the movable portion to move relative to the fixed portion.

### CROSS REFERENCE TO RELATED APPLICATIONS

This application claims the benefit of U.S. Provisional Application No. 63/436,291, filed Dec. 30, 2022, the entirety of which is incorporated by reference herein.

### BACKGROUND OF THE INVENTION

### Field of the Invention

The application relates in general to an optical member driving mechanism, and in particular, to an optical member driving mechanism for driving an optical member to move.

### Description of the Related Art

As technology has advanced, a lot of electronic devices (for example, tablet computers and smartphones) have been given the functionality of taking photographs and recording video. These electronic devices have become more commonplace, and have been developed to be more convenient and thin. More and more choices are provided for users to choose from.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move relative to the fixed portion.

In some embodiments, the driving assembly includes a first circuit component, a second circuit component, a control member, an inner elastic member, an outer elastic member, a supporting member, a first electromagnetic element, and a circuit assembly. The second circuit component is disposed on the frame and connected to the first circuit component. The control member is disposed on the second circuit component. The inner elastic member is connected to the holder and the frame. The outer elastic member is connected to the frame. The supporting member is connected to the outer elastic member and the fixed portion. The first electromagnetic element is disposed on the holder and electrically connected to the control member through the inner elastic member, the first circuit component and the second circuit component. The circuit assembly is embedded in the fixed portion and electrically connected to the control member through the supporting member, the outer elastic member, the first circuit component, and the second circuit component.

In some embodiments, the inner elastic member and the outer elastic member are separated from each other.

In some embodiments, the thickness of the inner elastic member along the optical axis of the optical member is different from the thickness of the outer elastic member along the optical axis of the optical member.

In some embodiments, the frame has a first lower surface, a first connecting surface, and a second connecting surface, the inner elastic member is connected to the first connecting surface, and the outer elastic member is connected to the second connecting surface, wherein a distance between the lower surface and the first connecting surface is different from a distance between the lower surface and the second connecting surface.

In some embodiments, the top surface of the inner elastic member is coplanar with the top surface of the outer elastic member.

In some embodiments, the frame has protruding portion, and the outer elastic member has a hole, wherein the protruding portion is accommodated in the hole, and the dimensions of the hole are greater than the dimensions of the protruding portion.

In some embodiments, the outline of at least a portion of the hole corresponds to the appearance of the protruding portion.

In some embodiments, the outer elastic member includes a fixed section and a free section, the fixed section is affixed to the frame, and the free section is connected to the fixed section and protrudes from a lateral surface of the frame.

In some embodiments, the supporting member is connected to the free section.

In some embodiments, the fixed portion includes a base, and the driving assembly includes a supporting member, a coil plate, and a circuit assembly. The supporting member is connected to the movable portion and the base. The coil plate is disposed on the base. The circuit assembly is embedded in the base and includes a first section, a second section, a terminal, and a third section. The first section is connected to the supporting member, and a first distance is formed between the bottom surface of the first section and the bottom surface of the base. The second section is connected to the coil plate, and a second distance is formed between the bottom surface of the second section and the bottom surface of the base. The terminal is configured to connect an external circuit. The third section is connected to the terminal, and a third distance is formed between the bottom surface of the third section and the bottom surface of the base. The first distance is different from the second distance and the third distance, and the second distance is different from the third distance.

In some embodiments, the second distance is greater than the first distance, and the first distance is greater than the third distance.

In some embodiments, the driving assembly further includes an electronic member disposed on the base, and the circuit assembly further includes a fourth section connected to the electronic member, wherein a fourth distance is formed between the bottom surface of the fourth section and the bottom surface of the base, and the fourth distance is different from the first distance, the second distance, and the third distance.

In some embodiments, the third distance is greater than the fourth distance.

In some embodiments, a recess is formed on the top surface of the base, and the electronic member is accommodated in the recess.

In some embodiments, the base includes at least two strip members disposed on the top surface of the base, and the strip members are with different distances from the supporting member, wherein the optical member driving mechanism further includes a buffering member disposed between the strip members, and the buffering member is in contact with the base and the movable portion.

In some embodiments, one of the strip members has an arc structure, and another one of the strip members has an L-shaped structure.

In some embodiments, the base has a recess formed on the bottom surface of the base, and the circuit assembly is exposed from the recess.

In some embodiments, the fixed portion includes a housing, and the optical member driving mechanism further includes an adhesive member, wherein the housing and the base are engaged with each other via the adhesive member, and the adhesive member is accommodated in the recess.

In some embodiments, the adhesive member is merely exposed from the bottom of the optical member driving mechanism.

### BRIEF DESCRIPTION OF DRAWINGS

The invention can be more fully understood by reading the subsequent detailed description and examples with references made to the accompanying drawings, wherein:

FIG. 1 is a schematic diagram of an optical member driving mechanism, an electronic device, and an optical member according to an embodiment of the invention;

FIG. 2 is a schematic diagram of the optical member driving mechanism according to an embodiment of the invention;

FIG. 3 is an exploded-view diagram of the optical member driving mechanism according to an embodiment of the invention;

FIG. 4 is a cross-sectional view taken along the line A-A in FIG. 2;

FIG. 5 is a schematic diagram of the optical member driving mechanism according to an embodiment of the invention, wherein an housing thereof is omitted;

FIG. 6 is a cross-sectional view taken along the line B-B in FIG. 2;

FIG. 7 is a cross-sectional view taken along the line C-C in FIG. 2;

FIG. 8 is a schematic diagram of the circuit assembly according to an embodiment of the invention;

FIG. 9 is a schematic diagram of the coil plate, the supporting member, the circuit assembly, and the base according to an embodiment of the invention;

FIG. 10 is a bottom view of the optical member driving mechanism according to an embodiment of the invention, wherein the adhesive member is omitted; and

FIG. 11 is a schematic diagram represents that the buffering member is disposed between two strip members according to an embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

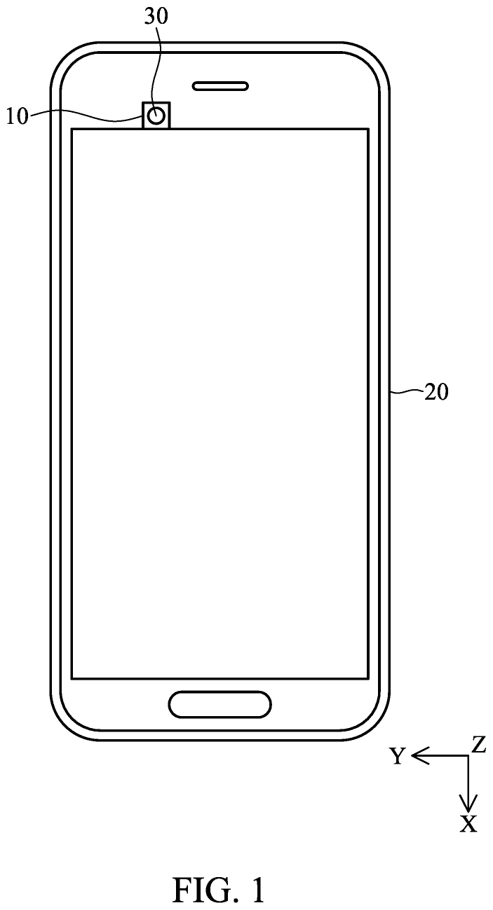

Referring to FIG. 1, an optical member driving mechanism 10 according to an embodiment of the invention can be disposed in an electronic device 20. The optical member driving mechanism 10 can be configured to hold and drive an optical member 30, so that the optical member 30 can move relative to an image sensor (not shown) in the electronic device 20, and the purpose of focusing, zooming, and/or optical image stabilization (OIS) can be achieved. For example, the electronic device 20 can be a smartphone, a tablet computer, or a digital camera, and the optical member 30 can be a camera lens with a plurality of lenses, but it is not limited thereto.

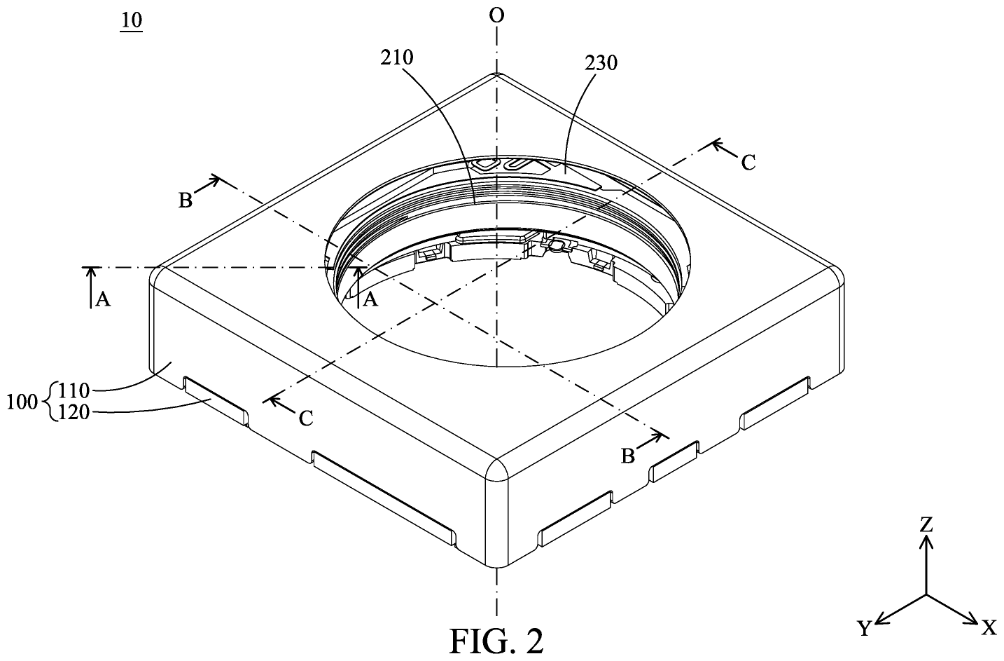

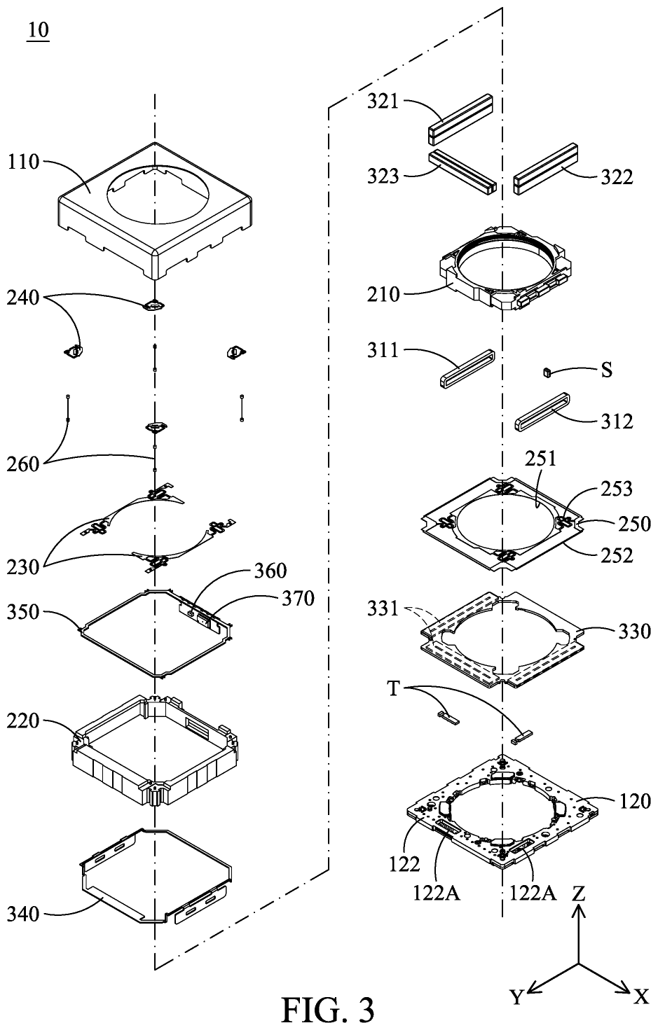

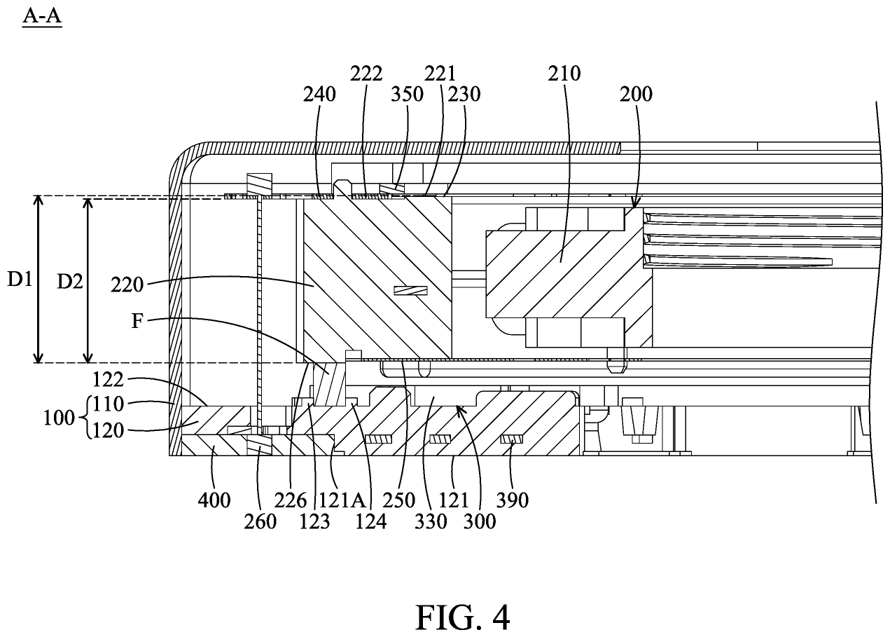

FIG. 2 is a schematic diagram of the optical member driving mechanism 10, FIG. 3 is an exploded-view diagram of the optical member driving mechanism 10, and FIG. 4 is a cross-sectional view taken along the line A-A in FIG. 2. As shown in FIG. 2 to FIG. 4, the optical member driving mechanism 10 primarily includes a fixed portion 100, a movable portion 200, and a driving assembly 300.

The fixed portion 100 includes a housing 110 and a base 120. The housing 110 and a base 120 can be engaged with each other by at least one adhesive member 400 to form a hollow box. The movable portion 200 and the driving assembly 300 can be accommodated in the hollow box formed by the housing 110 and the base 120, so that the fixed portion 100 can protect the movable portion 200 and the driving assembly 300. At least one recess 121A can be formed on the bottom surface 121 of the base 120. The adhesive member 400 can be accommodated in the recess 121A and in contact with the housing 110 and the base 120 to engage them. In this embodiment, the adhesive member 400 is merely exposed from the bottom of the optical member driving mechanism 10, so that other electronic components right beside the optical member driving mechanism 10 can be prevented from attaching to the adhesive member 400.

The movable portion 200 includes a holder 210, a frame 220, a plurality of inner elastic members 230, a plurality of outer elastic members 240, a lower elastic member 250, and a plurality of supporting members 260. The holder 210 is configured to hold the optical member 30, and can be movably connected to the frame 220 by the inner elastic members 230 and the lower elastic member 250.

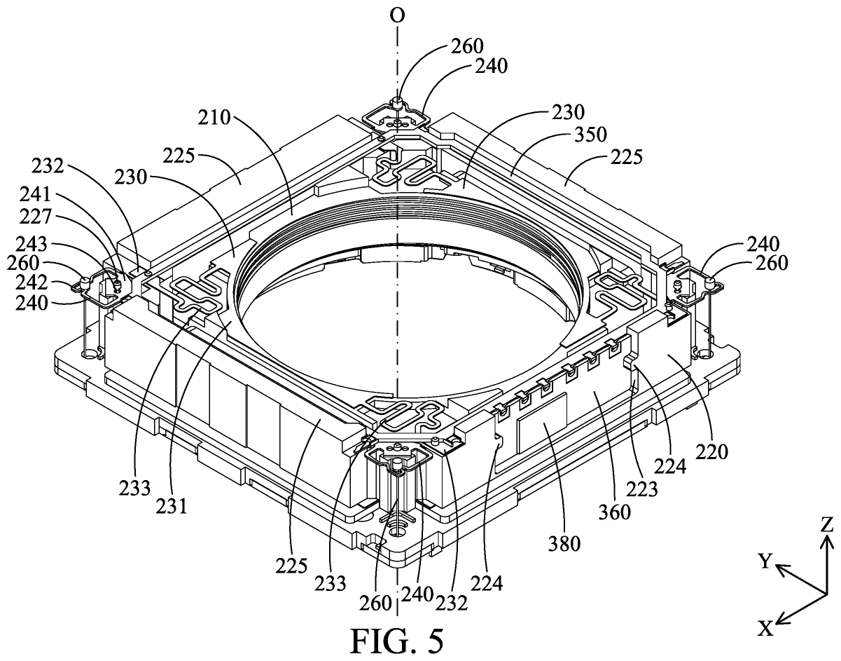

In detail, as shown in FIG. 3 to FIG. 5, each of the inner elastic members 230 includes at least one holder fixing section 231, at least one frame fixing section 232, and at least one string section 233. The holder fixing section 231 is connected to the upper surface of the holder 210, the frame fixing section 232 is connected to the upper surface of the frame 220, and the string section 233 is disposed between the holder fixing section 231 and the frame fixing section 232 and connected to them. Similarly, the lower elastic member 250 includes at least one holder fixing section 251, at least one frame fixing section 252, and at least one string section 253. The holder fixing section 251 is connected to the lower surface of the holder 210, the frame fixing section 252 is connected to the lower surface of the frame 220, and the string section 253 is disposed between the holder fixing section 251 and the frame fixing section 252 and connected to them. Therefore, the holder 210 can be hung in the frame 220.

The frame 220 can be movably connected to the base 120 by the outer elastic members 240 and the supporting members 260. Each of the outer elastic members 240 has a fixed section 241 and a free section 242. The fixed section 241 is affixed to the upper surface of the frame 220. The free section 242 is connected to the fixed section 241 and protrudes from the lateral surface of the frame 220. Each of the supporting members 260 has a longitudinal structure extending along the optical axis O of the optical member 30. One end of each supporting member 260 is affixed to the free section 242 of the outer section member 240, and the other end of each supporting member 260 is affixed to the base 120 of the fixed portion 100. For example, each supporting member 260 includes a suspension wire that is elastic, but it is not limited thereto.

In this embodiment, each outer elastic member 240 has a hole 243 formed on the fixed section 241 thereof. The frame 220 has a protruding portion 227 passing through the hole 243 and accommodated in the hole 243. The dimensions of the hole 243 can be greater than the dimensions of the protruding portion 227, therefore, when the user uses the glue to affix the fixed section 241 to the frame 220, the contact area of the glue can be increased and the reliability can be enhanced. The outline of at least a portion of the hole 243 can correspond to the appearance of the protruding portion 227, so that the positioning of each outer elastic member 240 can be facilitated.

The inner elastic members 230 and the outer elastic members 240 can be electrically connected to the driving assembly 300, so that they can be a path configured to transmit the current. Specifically, the inner elastic members 230 can be separated from the outer elastic members 240, and the thickness of each inner elastic member 230 along the optical axis O can be different from the thickness of each outer elastic member 240 along the optical axis O (for example, the thickness of each inner elastic member 230 can be less than the thickness of each outer elastic member 240). Thus, the inner elastic members 230 and the outer elastic members 240 can provide current paths independently and can provide different elastic forces.

Moreover, the surface of the frame 220 connected to the inner elastic members 230 can be defined as a first connecting surface 221, and the surface of the frame 220 connected to the outer elastic member 240 can be defined as a second connecting surface 222. The distance D1 between the first connecting surface 221 and the lower surface 226 of the frame 220 can be different to the distance D2 between the second connecting surface 222 and the lower surface 226 of the frame 220. Therefore, the top surfaces of the inner elastic members 230 and the outer elastic members 240 can be coplanar, and the placement of other member in the optical driving mechanism 10 (such as the driving assembly 300) can be facilitated.

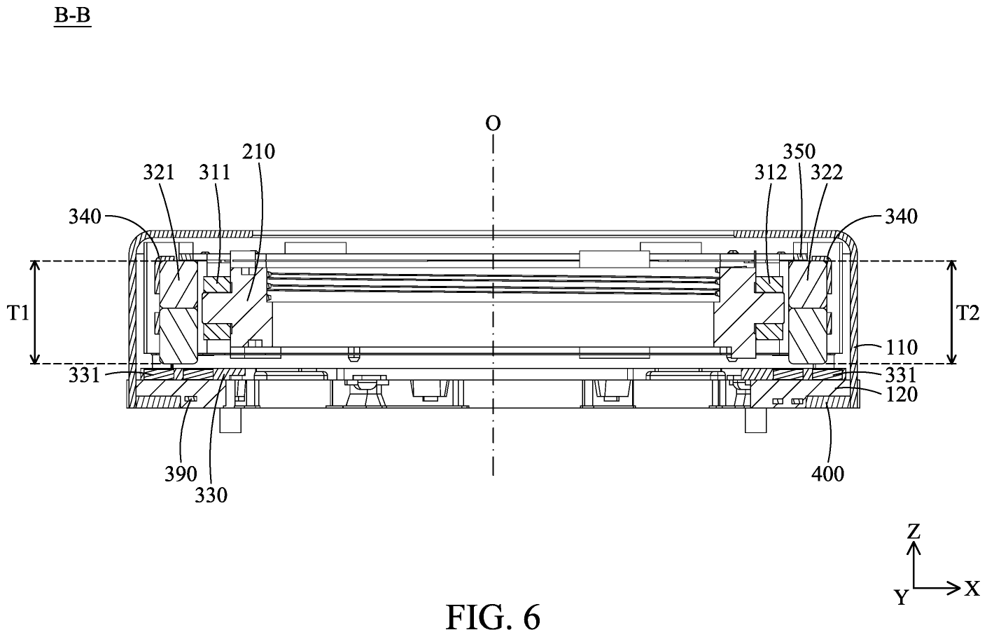

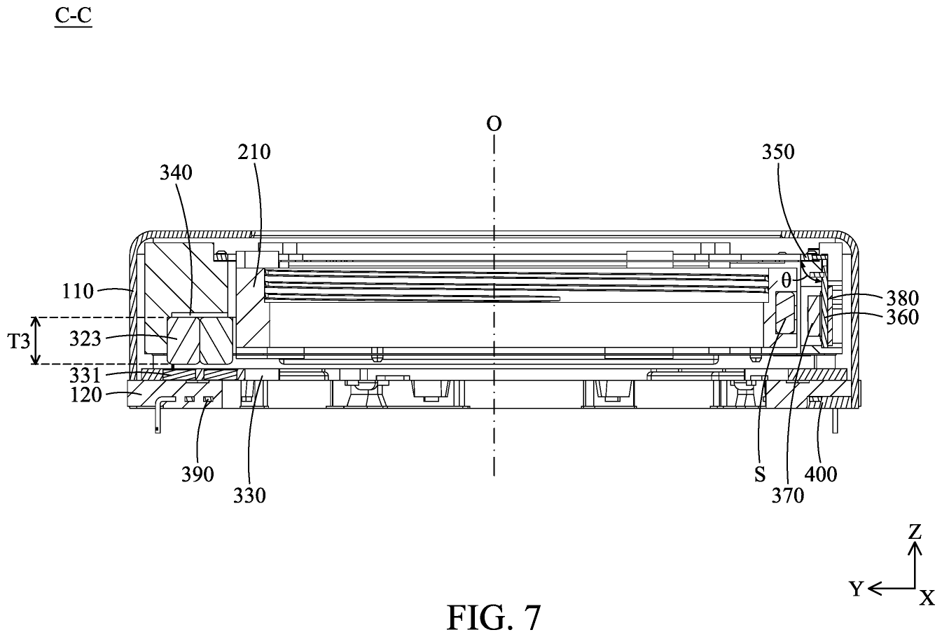

FIG. 6 is a cross-sectional view taken along the line B-B in FIG. 2, and FIG. 7 is a cross-sectional view taken along the line C-C in FIG. 2. As shown in FIG. 3, FIG. 6, and FIG. 7, the driving assembly 300 includes a first electromagnetic driving element 311, a second electromagnetic driving element 312, a first electromagnetic driving member 321, a second electromagnetic driving member 322, a third electromagnetic driving member 323, a coil plate 330, and a magnetically permeable member 340.

The first electromagnetic driving element 311 and the second electromagnetic driving element 312 are disposed on the holder 210, and respectively situated at the opposite sides of the holder 210. The first electromagnetic driving member 321 and the second electromagnetic driving member 322 are disposed on the frame 220. The position of the first electromagnetic driving member 321 corresponds to the position of the first electromagnetic driving element 311, and the position of the second electromagnetic driving member 322 corresponds to the position of the second electromagnetic driving element 312.

For example, each of the first electromagnetic driving element 311 and the second electromagnetic driving element 312 can be a coil, and each of the first electromagnetic driving member 321 and the second electromagnetic driving member 322 can be a magnet. When current flows through the first electromagnetic driving element 311 and the second electromagnetic driving element 312, the electromagnetic effect between the first electromagnetic driving element 311 and the first electromagnetic driving member 321 and the electromagnetic effect between the second electromagnetic driving element 312 and the second electromagnetic driving member 322 can provide a driving force to push the holder 210 to move relative to the frame 220 along the optical axis O of the optical member 30. Therefore, the purpose of zooming or focusing can be achieved.

The third electromagnetic driving member 323 is disposed on the frame 220, and the first electromagnetic driving member 321, the second electromagnetic driving member 322, and the third electromagnetic driving member 323 are disposed on different sides of the holder 210. The coil plate 330 is disposed on the base 120, and has a plurality of coils 331 corresponding to the first electromagnetic driving member 321, the second electromagnetic driving member 322, and the third electromagnetic driving member 323.

When current flows through the coils 331 of the coil plate 330, the electromagnetic effect between the coils 331 and the first, second, and third electromagnetic driving members 321, 322, and 323 can provide a driving force to push the frame 220 to move relative to the frame 220 along a direction that is perpendicular to the optical axis O of the optical member 30 (such as along the X-axis and/or the Y-axis). The holder 210 connected to the frame 220 can move accordingly, therefore, the purpose of optical image stabilization can be achieved.

In this embodiment, the direction of the magnetic field lines inside the third electromagnetic driving member 323 is different from the direction of the magnetic field lines inside the first electromagnetic driving member 321 and the second electromagnetic driving member 322, and the thickness T3 of the third electromagnetic driving member 323 along the optical axis O of the optical member 30 is less than the thickness T1 of the first electromagnetic driving member 321 and the thickness T2 of the second electromagnetic driving member 322 along the optical axis O of the optic member 30.

The magnetically permeable member 340 can be embedded in the frame 220, and at least a portion of the magnetically permeable member 340 can be disposed between the first, second, third electromagnetic driving members 321, 322. 323 and the frame 220 to enhance the driving effect of the optical member driving mechanism 10.

Referring to FIG. 3 to FIG. 7, in this embodiment, the driving assembly 300 further includes a first circuit component 350, a second circuit component 360, a control member 370, a magnetic shield member 380, and a circuit assembly 390. The first circuit component 350 can be a circuit board. The first circuit component 350 is affixed to the frame 220 and has an annular structure. When viewed along the optical axis O of the optical member 30, the first circuit component 350 surrounds the holder 210. In particular, the first circuit component 350 is affixed to the frame fixing sections 232 of the inner elastic members 230 and the fixed sections 241 of the outer elastic members 240 (for example, via soldering or using the screw or the rivet to engage). Therefore, the inner elastic members 230 and the outer elastic members 240 can be electrically connected to the first circuit component 350.

Similarly, the second circuit component 360 can be a circuit board. The second circuit component 360 is disposed on the frame 220, and the holder 210 is disposed between the second circuit component 360 and the third electromagnetic driving member 323. The second circuit component 360 can be electrically connected to the first circuit component 350, and an included angle θ can be formed between the second circuit component 360 and the first circuit component 350. The included angle θ is greater than 0 degrees and less than 180 degrees. In this embodiment, the included angle θ between the second circuit component 360 and the first circuit component 350 is about 90 degrees.

The second circuit component 360 is accommodated in a recess 223 of the frame 220. The opening of the recess 223 is located at the upper surface of the frame 220, and the second circuit component 360 is exposed from the opening to facilitate the user to solder. Furthermore, the frame 220 further includes at least one positioning portion 224 and at least one positioning portion 225. The positioning portion 224 protrudes from the inner wall of the recess 223 and corresponds to the appearance of the second circuit component 360, so as to position the second circuit component 360. The positioning portion 225 protrudes from the upper surface of the frame 220. The surface of the positioning portion 225 facing the first circuit component 350 corresponds to the appearance of the first circuit component 350, so as to position the first circuit component 350.

The control member 370 is disposed on the second circuit component 360 and configured to control the movement of the movable portion 200 relative to the fixed portion 100. The control member 370 can be electrically connected to the first electromagnetic component 311 and the second electromagnetic component 312 through the second circuit component 360, the first circuit component 350, and the inner elastic members 230 in sequence. The control member 370 can be electrically connected to the circuit assembly 390 through the second circuit component 360, the first circuit component 350, the outer elastic members 240, and the supporting members 260 in sequence.

The magnetic shield member 380 is disposed on the second circuit component 360, and the second circuit component 360 is disposed between the control member 370 and the magnetic shield member 380. The dimensions of the magnetic shield member 380 are greater than the dimensions of the control member 370. When viewed along the direction that is perpendicular to the optical axis O (such as the Y-axis), the magnetic shield member 380 covers the control member 370. Therefore, the driving effect of the driving assembly 300 can be enhanced.

In this embodiment, the driving assembly 300 further includes a sensing object S, and the control member 370 is an all-in-one driver IC. That is, there is a sensor in the control member 370. The sensing object S can be disposed on the holder 210, and the position of the sensing object S can correspond to the control member 370.

The control member 370 can detect the position of the sensing object S to obtain the position of the holder 210 relative to the frame 220. For example, the sensor in the control member 370 can be a Hall sensor, a magnetoresistance effect sensor (MR sensor), a giant magnetoresistance effect sensor (GMR sensor), a tunneling magnetoresistance effect sensor (TMR sensor), or a fluxgate sensor, but it is not limited thereto.

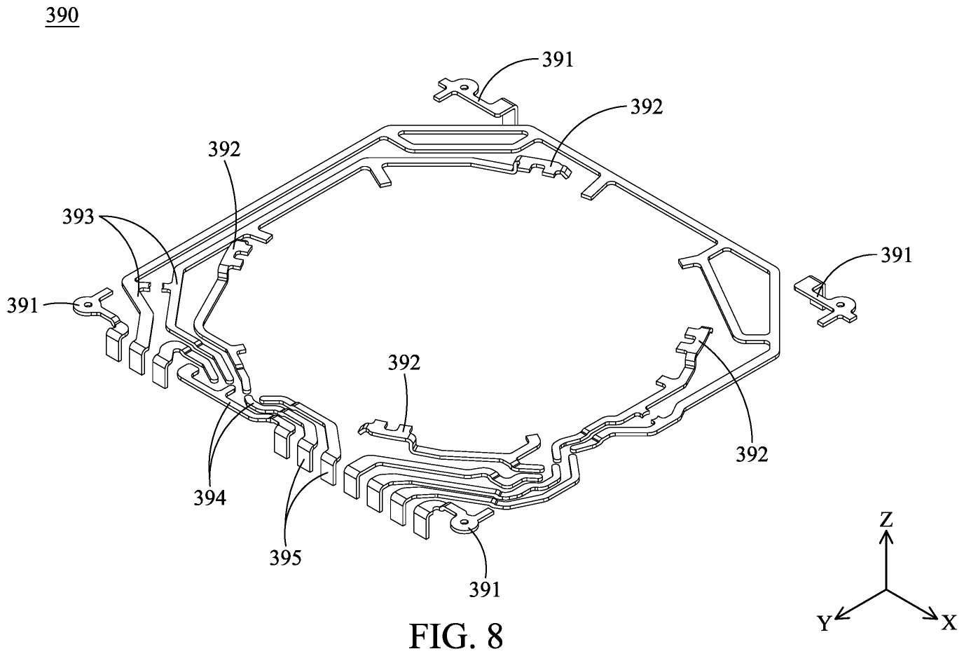

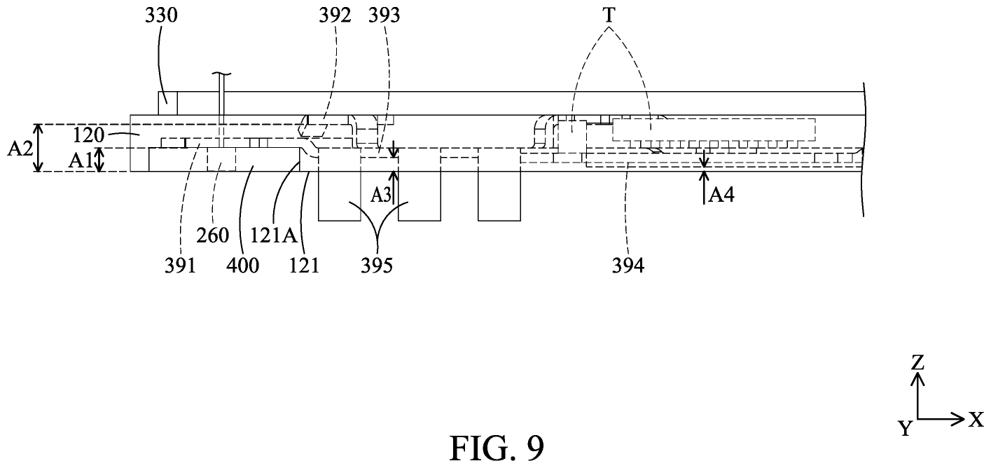

As shown in FIG. 3, FIG. 8, and FIG. 9, the circuit assembly 390 is embedded in the base 120, and includes a plurality of circuits that are independent with each other. In detail, the circuit assembly 390 can include at least one first section 391, at least one second section 392, at least one third section 393, at least one fourth section 394, and a plurality of terminals 395. The first section 391 is connected to the supporting member 260. For example, the adhesive member 400 can affix the end of the supporting member 260 to the first section 391 in the recess 121A of the base 120. The second section 392 is connected to the coils 331 of the coil plate 330. The third section 393 is connected to the terminals 395, and the terminals 395 can be extended to the outer of the base 120 to electrically connect the other electronic component(s) in the electronic device 20. The fourth section 394 is connected to at least one electronic member T that is disposed on the base 120. The electronic member T can be accommodated in the recess 122A that is formed on the top surface 122 of the base 120, and can be covered by the coil plate 330. For example, the electronic member T can include the driver IC and/or the position sensor.

In some circuits, the third section 393 can further connect to the first section 391, the second section 392, or the fourth section 394. In some circuits, the first section 391, the second section 392, or the fourth section 394 can directly connect to the terminals 395, but it is not limited thereto.

When viewed along the direction perpendicular to the optical axis O, a first distance A1 can be formed between the bottom surface of the first section 391 and the bottom surface 121 of the base 120, a second distance A2 can be formed between the bottom surface of the second section 392 and the bottom surface 121 of the base 120, a third distance A3 can be formed between the bottom surface of the third section 393 and the bottom surface 121 of the base 120, and a fourth distance A4 can be formed between the bottom surface of the fourth section 394 and the bottom surface 121 of the base 120. The first distance A1, the second distance A2, the third distance A3, and the fourth distance A4 are different. In this embodiment, the second distance A2 is greater than the first distance A1, the first distance A1 is greater than the third distance A3, and the third distance A3 is greater than the fourth distance A4. Therefore, the base 120 can include sufficient thickness even when the circuit assembly 390 is embedded therein.

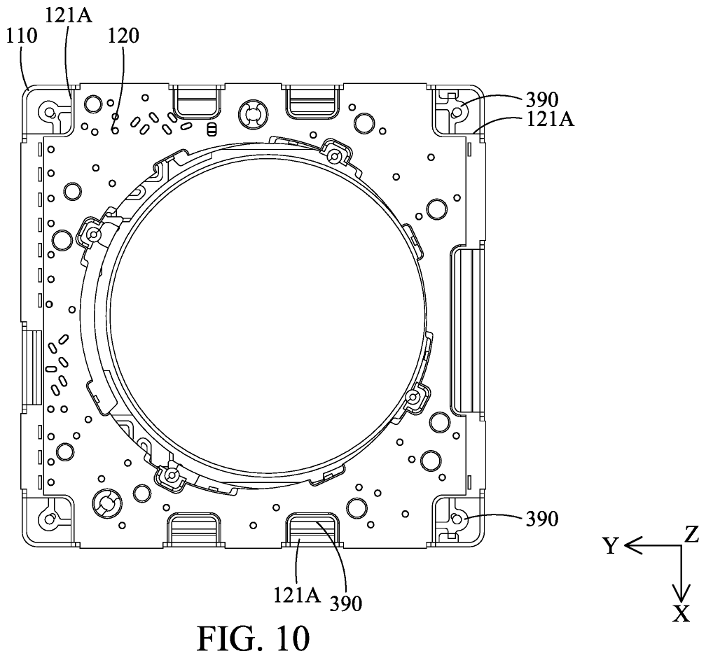

Moreover, as shown in FIG. 10, in this embodiment, before the adhesive member 400 is filled into the recess 121A, the circuit assembly 390 can be exposed from the recess 121A. Therefore, it is facilitated to check the position of the circuit assembly 390. When the adhesive member 400 is filled into the recess 121A, the adhesive member 400 can be in contact with the circuit assembly 390 and the base 120, so that the circuit assembly 390 can be affixed more steadily.

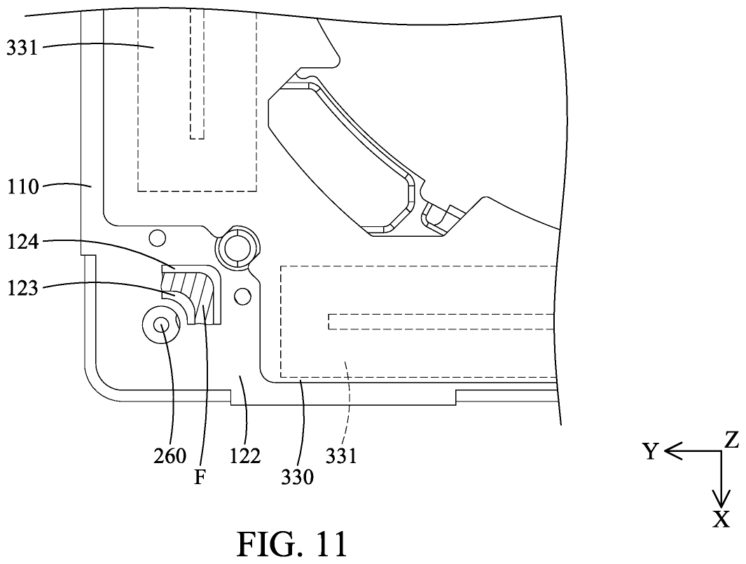

As shown in FIG. 4 and FIG. 11, in this embodiment, the optical member driving mechanism 10 can further includes at least on buffering member F, and two strip members 123 and 124 can be formed on the top surface 122 of the base 120 and adjacent to each supporting member 260. The strip members 123 and 124 protrude from the top surface 122. The distance between the strip member 123 and the supporting member 260 is different from the distance between the strip member 124 and the supporting member 260, and a gap is formed between the strip member 123 and the strip member 124. The buffering member F is disposed in the gap between the strip member 123 and the strip member 124, and is in contact with the base 120 and the frame 220 to reduce the oscillation during the movement the movable portion moves. For example, the buffering member F includes a gel, but it is not limited thereto.

In this embodiment, the strip member 123 has an arc structure, and the circle center of the arc structure is situated at the position of the supporting member 260, so that all portions of the strip member 123 has the same distance from the supporting member 260. The strip member 124 substantially has an L-shaped structure, but it is not limited thereto.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move relative to the fixed portion.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move relative to the fixed portion.

2. The optical member driving mechanism as claimed in claim 1, wherein the movable portion comprises a holder and a frame, and the driving assembly comprises:
a first circuit component;
a second circuit component, disposed on the frame and connected to the first circuit component;
a control member, disposed on the second circuit component;
an inner elastic member, connected to the holder and the frame;
an outer elastic member, connected to the frame;
a supporting member, connected to the outer elastic member and the fixed portion;
a first electromagnetic element, disposed on the holder and electrically connected to the control member through the inner elastic member, the first circuit component and the second circuit component; and
a circuit assembly, embedded in the fixed portion and electrically connected to the control member through the supporting member, the outer elastic member, the first circuit component, and the second circuit component.

3. The optical member driving mechanism as claimed in claim 2, wherein the inner elastic member and the outer elastic member are separated from each other.

4. The optical member driving mechanism as claimed in claim 2, wherein a thickness of the inner elastic member along an optical axis of the optical member is different from a thickness of the outer elastic member along the optical axis of the optical member.

5. The optical member driving mechanism as claimed in claim 2, wherein the frame has a first lower surface, a first connecting surface, and a second connecting surface, the inner elastic member is connected to the first connecting surface, and the outer elastic member is connected to the second connecting surface, wherein a distance between the lower surface and the first connecting surface is different from a distance between the lower surface and the second connecting surface.

6. The optical member driving mechanism as claimed in claim 5, wherein a top surface of the inner elastic member is coplanar with a top surface of the outer elastic member.

7. The optical member driving mechanism as claimed in claim 2, wherein the frame has protruding portion, and the outer elastic member has a hole, wherein the protruding portion is accommodated in the hole, and dimensions of the hole are greater than dimensions of the protruding portion.

8. The optical member driving mechanism as claimed in claim 7, wherein an outline of at least a portion of the hole corresponds to an appearance of the protruding portion.

9. The optical member driving mechanism as claimed in claim 2, wherein the outer elastic member comprises a fixed section and a free section, the fixed section is affixed to the frame, and the free section is connected to the fixed section and protrudes from a lateral surface of the frame.

10. The optical member driving mechanism as claimed in claim 9, wherein the supporting member is connected to the free section.

11. The optical member driving mechanism as claimed in claim 1, wherein the fixed portion comprises a base, and the driving assembly comprises:
a supporting member, connected to the movable portion and the base;
a coil plate, disposed on the base; and
a circuit assembly, embedded in the base and comprising:
a first section, connected to the supporting member, wherein a first distance is formed between a bottom surface of the first section and a bottom surface of the base;
a second section, connected to the coil plate, wherein a second distance is formed between a bottom surface of the second section and the bottom surface of the base;
a terminal, configured to connect an external circuit; and
a third section, connected to the terminal, wherein a third distance is formed between a bottom surface of the third section and the bottom surface of the base, wherein the first distance is different from the second distance and the third distance, and the second distance is different from the third distance.

12. The optical member driving mechanism as claimed in claim 11, wherein the second distance is greater than the first distance, and the first distance is greater than the third distance.

13. The optical member driving mechanism as claimed in claim 11, wherein the driving assembly further comprises an electronic member disposed on the base, and the circuit assembly further comprises a fourth section connected to the electronic member, wherein a fourth distance is formed between a bottom surface of the fourth section and the bottom surface of the base, and the fourth distance is different from the first distance, the second distance, and the third distance.

14. The optical member driving mechanism as claimed in claim 13, wherein the third distance is greater than the fourth distance.

15. The optical member driving mechanism as claimed in claim 13, wherein a recess is formed on a top surface of the base, and the electronic member is accommodated in the recess.

16. The optical member driving mechanism as claimed in claim 11, wherein the base comprises at least two strip members disposed on the top surface of the base, and the strip members are with different distances from the supporting member, wherein the optical member driving mechanism further comprises a buffering member disposed between the strip members, and the buffering member is in contact with the base and the movable portion.

17. The optical member driving mechanism as claimed in claim 16, wherein one of the strip members has an arc structure, and another one of the strip members has an L-shaped structure.

18. The optical member driving mechanism as claimed in claim 11, wherein the base has a recess formed on the bottom surface of the base, and the circuit assembly is exposed from the recess.

19. The optical member driving mechanism as claimed in claim 18, wherein the fixed portion comprises a housing, and the optical member driving mechanism further comprises an adhesive member, wherein the housing and the base are engaged with each other via the adhesive member, and the adhesive member is accommodated in the recess.

20. The optical member driving mechanism as claimed in claim 19, wherein the adhesive member is merely exposed from a bottom of the optical member driving mechanism.
